(19) United States
(12) Patent Application Publication
(10) Pub. No.: US 2009/0321351 A1
(43) Pub. Date: Dec. 31, 2009

(54) BIOREMEDIATION BLANKET AND METHOD OF USE

(76) Inventor: William I. Young, North Scituate, MA (US)

Correspondence Address: BIRCH STEWART KOLASCH & BIRCH, PO BOX 747, FALLS CHURCH, VA, 22040-0747, US

(21) Appl. No.: 12/304,745

(22) PCT Filed: Jun. 14, 2007
(86) PCT No.: PCT/US07/71219

§ 371 Date: Aug. 24, 2009

Related U.S. Application Data
(60) Provisional application No. 60/813,365, filed on Jun. 14, 2006.

(51) Int. Cl. C02F 3/00

(52) U.S. Cl. 210/615; 134/10; 210/170.01

(57) ABSTRACT

Bioremediation blanket including: top layer adapted to capture and remove material floating in water and to contain material removed from water on blanket and to allow hydrocarbons to flow through top layer to the interior of blanket; interior with microbes adapted to digest hydrocarbons and optionally containing support for the microbes and/or optionally containing material to absorb heavy metals present in interior layer; and bottom layer comprising monofilament woven layer adapted to release bioremediated water. Method for removing hydrocarbons from water by: providing bioremediation blanket; allowing water containing hydrocarbons to contact and penetrate the blanket; and allowing microbes within the blanket to digest the hydrocarbons. Method for pressure washing boats by: providing bioremediation blanket; placing the blanket, top side up, underneath a boat; pressure washing the boat and allowing water containing hydrocarbons generated by pressure washing to contact and penetrate the blanket; and allowing microbes within the blanket to digest the hydrocarbons.

### FIELD OF THE INVENTION

This invention relates to a method for treating water. In particular, this invention provides a bioremediation blanket and a method of using the blanket for preventing hydrocarbons, other pollutants, and sediments such as barnacles and paint chips from entering the earth's surface and waterways, for instance during storm water run off or due to an outflow of pollutants, for example, from the pressure washing of boats or motor vehicles or structures. Alternatively, the bioremediation blanket of the present invention may be used underneath parked vehicles to absorb and treat water and hydrocarbon fluids dripping from their engine compartments. Additionally, the bioremediation blankets may be deployed on rooftop gardens and on overhangs on highways to address the problem of hydrocarbons and animal waste. The blanket can be deployed in retaining walls to reduce soil erosion.

### BACKGROUND OF THE INVENTION

Environmental laws and regulations set increasingly strict limits on the amount of pollutants that may be discharged from marinas into navigable waters, storm sewers, and so on. In order to meet many such laws and regulations, marinas are being compelled to adopt closed loop pressure washing systems, which are very expensive to install and maintain. The present invention has been developed to provide an alternative, distinctly less costly manner in which environmental laws and regulations affecting the discharge of pollutants from the pressure washing of boats and other vehicles and structures may be met in order to comply with The Clean Water Act. An application in which the present invention is particularly useful is with respect to the pressure washing of boats in marinas. Another application in which the present invention is particularly useful is meeting EPA and federal regulations regarding stormwater runoff. Yet another application is use underneath parked vehicles in garages, for instance, fire engines, to absorb and treat water and hydrocarbon fluids dripping from the engine compartments of the vehicles.

### SUMMARY OF THE INVENTION

This invention is a method of both trapping and containing solid sediments such as paint chips, leaves, barnacles, and debris and bioremediating organic pollutants such as gas, oil, grease, fats, glycol, and even animal waste using microbes. More specifically, the present invention relates to a bioremediation blanket comprising microbes, adapted to digest hydrocarbons, and two layers of geotextile fabric, each of which layers is made from fabric designed to provide specific functions. The microbes may be located on one of said layers or between layers of the blanket.

In use in a pressure washing application, the blanket of this invention will have a top layer—above which the boat or other object being washed is located—and a bottom layer, facing away from the boat or other object being washed. In one embodiment of the invention, the top layer of the blanket is adapted to remove material floating in water and contain the material removed from the water on the blanket, and to allow hydrocarbons to penetrate within the blanket so that the microbes can contact the hydrocarbons. The microbes may be located on and/or within foam positioned on one of the layers or between the two layers. Alternatively, the microbes are located within a gap or pocket formed by or within the layers of the fabric. The interior of the blanket will trap the hydrocarbons and any dissolved sediments that were not contained on the outer layer. The microbes will digest the hydrocarbons and preferably the carrier (e.g., bentonite clay) housing the microbes will absorb the dissolved sediments.

The present invention also relates to a method for removing hydrocarbons from water, which comprises providing the bioremediation blanket, allowing water containing hydrocarbons to contact the blanket, and allowing the microbes to digest the hydrocarbons.

The final by-products of bioremediation in accordance with this invention are carbon dioxide, water, trace carbon, water-soluble fatty acids, and bacterial cells. The microbes begin working immediately, once activated by salt water or fresh water. Bioremediation times vary from several hours to several weeks depending on the type and concentration of the hydrocarbon. For example, light fuels floating on water will be gone within a few hours. Heavy crude oil in soil will require several months.

In one embodiment, this invention provides a bioremediation blanket made up of a top layer and a bottom layer. Microbes adapted to digest hydrocarbons are provided on or within the top layer and/or between the top layer and the bottom layer. The present blanket has directionality, because in use, contaminated water is generally allowed to enter the blanket from one side, typically the “top” side. For instance, in the pressure washing of boats, a bioremediation blanket in accordance with this invention is placed, top side up, underneath a boat, the boat is then pressure washed, water containing hydrocarbons generated by the pressure washing drips down onto and penetrates the blanket, and microbes within the bioremediation blanket digest the hydrocarbons.

The top layer of the bioremediation blanket is made of an oleophilic nonwoven geotextile fabric adapted to capture and remove material such as barnacles, leaves, paint chips, and sediments—floating in water and to contain the material removed from the water on the blanket and to allow hydrocarbons to flow through the top layer to the interior of the blanket. Preferably, the top layer generally has a flow rate of at least about 70 gallons per minute per square foot, and more preferably, of approximately 80 gallons per minute per square foot.

The interior of the bioremediation blanket encompasses microbes adapted to digest hydrocarbons and optionally contains a polymeric or agricultural product substrate support for the microbes and/or optionally also contains a material to absorb heavy metals that may be present such as copper, lead, zinc, and other metals in paint chips generated by the pressure washing of boats. The microbes may be present in the form of a tablet, powder, or liquid. The substrate may be, e.g., a polymeric foam substrate. If a polymeric foam substrate is used, the microbes may be located on and/or within the polymeric foam, the polymeric foam may be positioned on a layer (generally on or inside of the top layer) or between two layers. The material to absorb heavy metals may be, e.g., bentonite clay, carbon, zeolite, or chitosan to absorb copper, lead, or zinc. Often, no enzymes are present in the microorganism preparation incorporated into the remediation blanket of the present invention. Nutrients for the microbes are not required, either. However, nutrients for the microbes may be added to the blanket, if desired.

The bottom layer of the bioremediation blanket is made of a geotextile fabric comprising a woven monofilament layer adapted to release bioremediated water—that is, water from which hydrocarbons and optionally heavy metals such as copper, lead, and zinc have been removed. The bottom layer may be, e.g., a woven polypropylene monofilament fabric. Preferably, the bottom layer has a flow rate of at least about 15 gallons per minute per square foot; more preferably, of approximately 18 gallons per minute per square foot.

As discussed in detail below, layers of geotextile fabrics and microbes used to make up the bioremediation blanket of this invention may be held together by needle punching and/or by other conventional means such as stitching. The bioremediation blanket may be configured with an upright border extending along the entire perimeter of the top layer, the upright border being adapted to contain water, barnacles, paint chips, and sediments. The perimeter border will generally contain an internal member which imparts rigidity to the border. Examples of the rigidizing internal member are 4-inch by 4-inch lengths of wood or lengths of PVC pipe 4 inches in diameter. The bioremediation blanket may also, alternatively or additionally, be configured with two or more handles to facilitate handling and moving the blanket.

In using the bioremediation blanket of this invention, the dimensions of the blanket used—that is, the surface area and the depth of the border should generally be selected to provide sufficient bottom layer outflow capacity to handle the amount of unremediated water to be treated, and to avoid overflow of water and sediments, paint chips, etc., into the environment. For instance, in pressure washing a boat, a bioremediation blanket with a very large area relative to the boat and/or with very deep borders may be used. Alternatively, with a smaller blanket, the pressure washing procedure could be halted from time to time in order to permit the blanket to remediate the water which has already been generated before additional pressure washing water is generated. In many applications—e.g., use underneath parked vehicles to absorb and treat water and hydrocarbon fluids dripping from engine compartments, and deployment on rooftop gardens to remediate animal waste—the amount of the inflow of unremediated water will not be a major concern.

In a method embodiment of the present invention, a bioremediation blanket as described above is provided, water containing hydrocarbons is allowed to contact and penetrate the blanket, and microbes within the bioremediation blanket are allowed to digest the hydrocarbons, after which water, from which hydrocarbons and dissolved metals have been removed, is allowed to flow out of the blanket. In this method, material floating in the water is removed and retained on the blanket. The material may be removed from the blanket in order to clean and reuse the blanket. The step of allowing water containing hydrocarbons to contact and penetrate the blanket may be accomplished by situating a bioremediation blanket, top side up, underneath an engine compartment of a parked motor vehicle (e.g., a fire engine), or underneath a boat being pressured washed.

### BRIEF DESCRIPTION OF THE DRAWINGS

FIG. 1 is a schematic representation of a boat placed on a bioremediation blanket of the invention.

FIG. 2 is a photograph of a bioremediation blanket of the invention, rolled up and resting on the ground.

FIG. 3A is a partial perspective view of a bioremediation blanket embodiment of the invention, showing an upright retention border.

FIG. 3B is a partial perspective view of a bioremediation blanket embodiment of the invention, showing a PVC pipe providing rigidity to an upright border.

FIG. 4A is a side view schematic representation of a bioremediation blanket of the invention.

FIG. 4B is a top view schematic representation of a bioremediation blanket of the invention.

FIG. 5 is a top plan view of a bioremediation blanket of the invention.

FIG. 6 is a top plan view of foam sheets used as a substrate in the interior of a blanket of this invention.

### DETAILED DESCRIPTION OF THE INVENTION

### The Fabrics

Geotextiles are typically made from synthetic polymers such as polypropylene, polyester, polyethylenes, and polyamides. Geotextiles can be woven or knitted, or they can be nonwoven fabrics. Nonwoven geotextiles resemble felt and provide planar water flow. They often function as filter fabrics. A woven geotextile is a planar textile structure produced by interlacing two or more sets of strands at right angles. There are two types of strands: slit films, which are flat, and monofilaments, which are round. Woven monofilament geotextiles can provide both strength and filtration properties.

In the present invention, at least two layers of two different types of geotextile fabric are attached to each other face to face. Each type of geotextile fabric used to make the bioremediation blankets of this invention is selected to have particular properties. Polypropylene fabrics have been found to be useful for both the top and bottom layers of the present bioremediation blankets, but other types of synthetic polymer fabrics may be employed so long as they provide appropriate physical characteristics, as described in detail below. Geotextile materials that can be used in the present invention are commercially available, e.g., from Carthage Mills of Cincinnati, Ohio, and Huesker, Inc. of Charlotte, N.C.

The top layer herein is made from a nonwoven fabric that will trap the sediments and contain them while letting hydrocarbons and water flow through to be exposed to the microbes for bioremediation. Bioremediation refers to methods that employ microbes to recycle organic materials. Typical grades of nonwoven top layers in accordance with the present invention have a density of 8 ounces or 10 ounces per square yard. These grades of fabric are relatively thick. Their thickness provides a three-dimensional area which can serve as a habitat for bioremediation microbes and which permits horizontal, as well as vertical, water flow. Oleophilic polypropylene with a large surface area is particularly preferred for hydrocarbon adsorption.

A top layer suitable for the present invention will typically have a pore size of about 100 to 150 microns, to prevent penetration into the blanket of sediments larger than the pore size selected. Of course, other pore sizes—larger or smaller—may be appropriate for some applications. An advantage of using nonwoven geotextile fabric is that it generally has a rough surface, which has a “grabbing” effect on paint flakes or chips or sediment that will keep them in place on the blanket.

The top layer nonwoven geotextile fabric will preferably have an initial flow rate of at least about 80 gallons per minute per square foot, although an initial flow rate of 100 gallons per minute per square foot is preferred in many cases. Flow rate tends to diminish once sediments begin to accumulate in the fibers of the nonwoven layer. In any case, lower (or higher) flow rates are likewise operative.

The bottom layer is made from a woven monofilament fabric, e.g., with an open area of about 6%. Such fabrics have slick surfaces, which are less prone to snagging and which can easily be dragged over rough surfaces. The bottom layer is a strong yet lightweight fabric which reinforces the nonwoven layer to prevent stretching. Suitable bottom layer fabrics typically have U.S. Sieve pore sizes of 70 to 210 microns, although other pore sizes—larger or smaller—may be appropriate for some applications. The flow rate of the bottom layer is selected to be lower than the flow rate of the top layer, in order to provide the microbes with retention time to digest the hydrocarbons. A flow-through rate of approximately 18 gallons per minute has been found to be suitable for many applications, but lower (or higher) flow rates are likewise operative. This will facilitate treatment of the water before it flows into the earth's surface or into a catch basin. Typical bottom layer fabrics are woven monofilament fabrics or slit woven tapes, produced e.g. by Huesker, Inc. of Charlotte, N.C.

In an optional embodiment, the bottom layer may be made from polyethylene, with perforations or pre-punched microscopic holes. The polyethylene, being closed cell, would restrict the flow rate out of the blanket. The flow rate would be controlled by the degree of perforation or other holes imparted to the bottom layer. This embodiment could be employed in applications in which it is desired to provide the microbes with more time to digest the hydrocarbon load.

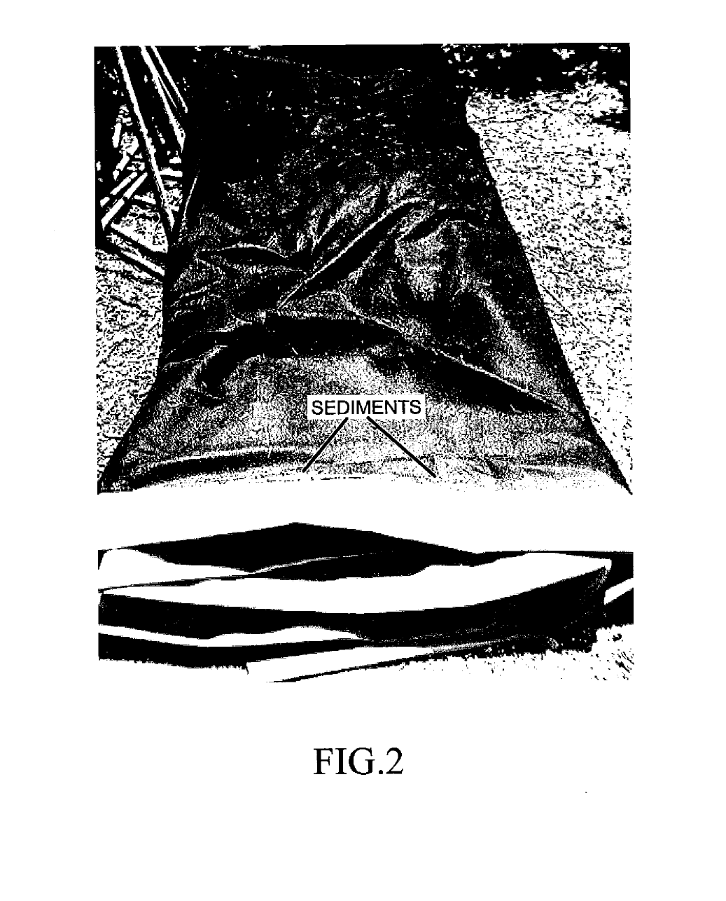

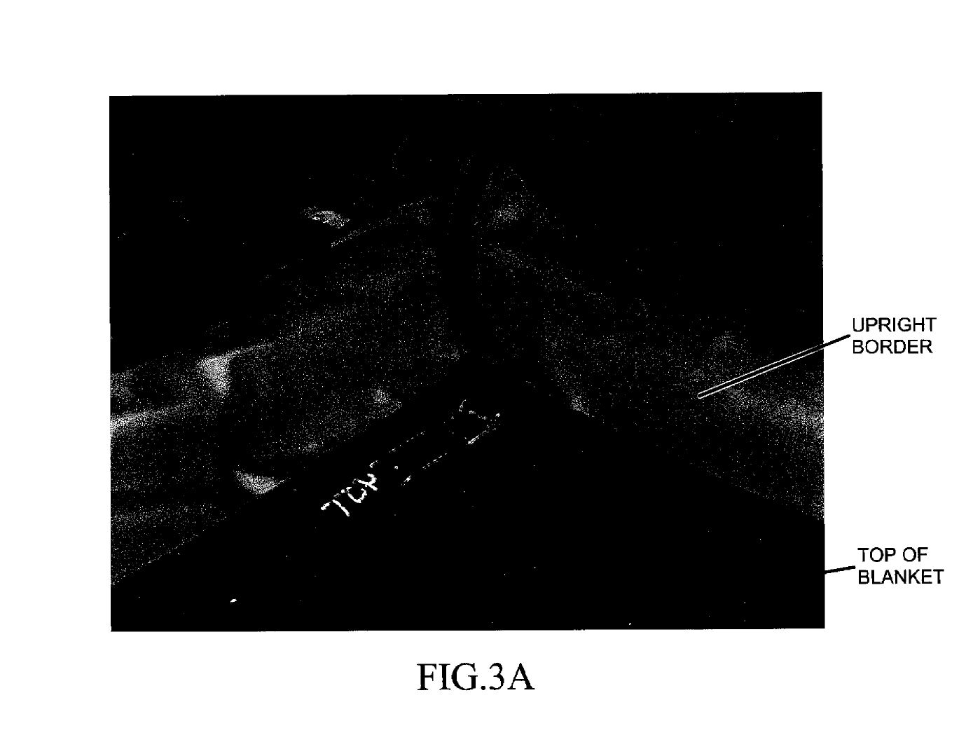

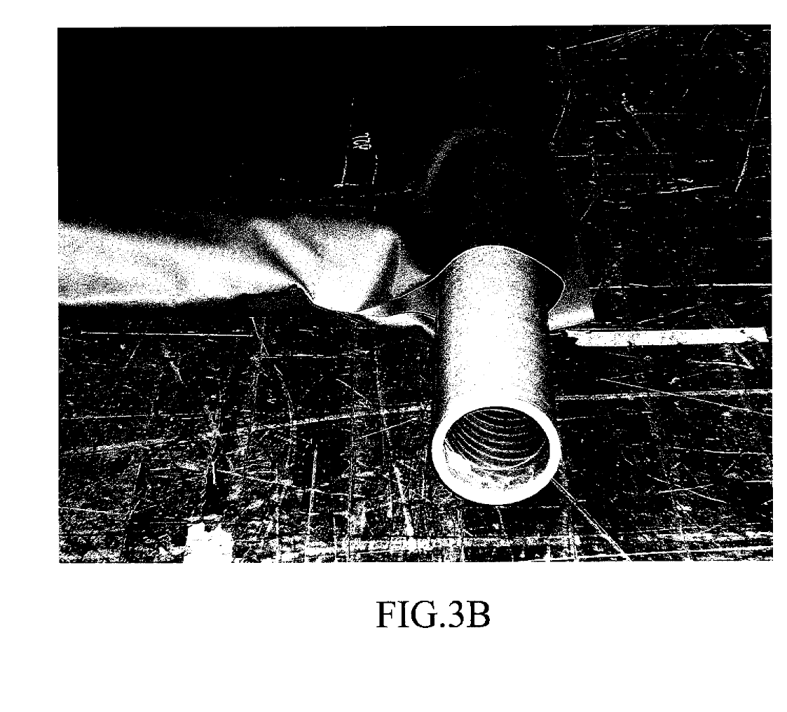

In a preferred embodiment of the bioremediation blanket of the present invention, illustrated in FIGS. 3A and 3B, the top layer may have a border on all four sides, e.g., made out of nylon or vinyl. As may be seen in FIG. 3B, the border may have an insert, e.g., of 4″×4″ wood or PVC pipe, to provide rigidity. The border should have sufficient height to keep the debris collected from the water on top of the blanket. This will serve to contain sediments, which can be collected for disposal by sweeping or vacuuming them up. FIG. 2 is a photograph of a bioremediation blanket of the invention, rolled up and resting on the ground. This particular embodiment has no handles and no upright border. The light colored border visible in FIG. 2 is a flat seal overlapping the joint between the top and bottom layers of the blanket. In FIG. 2, sediments which have been captured on the top surface can be seen as lighter copy deposits along the outside edge of the blanket.

In another embodiment of the invention, the microbes may be applied inside the layers of a multilayer mat. A mat may be made up, e.g., of a top layer of 10-ounce nonwoven polyester, an intermediate layer of 11-ounce meltblown polypropylene, an optional intermediate 2-ounce layer of slit woven polypropylene for more stability, and a bottom layer of woven polypropylene. The microbes are dispersed on the 11-ounce polypropylene layer, which has been meltblown to create a fluffy cell structure to better absorb hydrocarbons and dissolved metals. The layers of the blanket are attached by needle punching, which makes for a more stabilized end product. The needle punching process interlocks the fibers of the different layers. For this invention, needle punching should normally be the minimum amount necessary to provide structural integrity, since too much needle punching could result in excessive flow-through rates. The bioremediation blanket of this embodiment may also be configured with the upright border described elsewhere in this patent application.

### The Microbes

The bioremediation of organic pollutants is accomplished by subjecting the pollutants to the microbes as they flow through the nonwoven geotextile fabric. The present invention may utilize any microorganism known for its ability to remediate, or digest, hydrocarbons. The source of the microorganisms is not limited, so long as the microorganism has the ability to remediate the pollutant to be removed. The microorganism is preferably not auxotrophic.

Microorganisms from the domain Archaea are a preferable element of the present invention. It is known in the art that there are three major groups of prokaryotes, i.e., bacteria, Archaea, and Eukarya, which are classified based upon comparative genetic analysis of the nucleotide sequences of their small subunit ribosomal RNA (ssrRNA). In addition to differences in ssrRNA, microorganisms of domain Archaea also possess unifying archaeal features (i.e., no murein in cell wall, ester-linked membrane lipids, etc.) that differentiate them from bacteria. Many of these unique structural and biochemical attributes allow microorganisms of the domain Archaea to live in extreme habitats, including very high temperatures (hyperthermophiles) and very high concentrations of salt (extreme halophiles).

Any hydrocarbon-digesting organisms can be used as the microbe component of the present invention. Preferably, they are natural ubiquitous hydrocarbon-oxidizing microorganisms for use in removing hydrocarbons and organic matter by natural oxidative pathways. Microbes are of the Archaea variety can survive the harshest of environments and are garnered from hot springs, volcanoes, and ocean vents from all over the world. Such microbes are 100% environmentally safe, non-toxic, and contain no pathogens. The microbes can lie dormant for up to five years until activated. To be activated, they need water, oxygen, a hydrocarbon, and motion to promote contact between the microbes and the water, oxygen, and hydrocarbon. Sufficient motion is generally provided by the flow of water to be remediated into the blanket. Once activated they will digest the hydrocarbons. They will double in number every twenty minutes or so, and digest the hydrocarbon until it is gone turning the hydrocarbon into harmless water soluble fatty acids, carbon dioxide, water and bacterial cells.

As noted above, the present invention may utilize any microorganism known for its ability to remediate, or digest, hydrocarbons. Examples of such microorganisms are bacteria such as Pseudomonas sp., Acinetobacter sp., Metyiosinus sp. and the like. These microbes act to decompose many types of pollutants. For instance, they are suitable for removal of dyes having aromatic rings or furan structures, pigments, surfactants, surface-coating agents, adhesives, organic solvents, petroleum type pollutants, etc., from water. Other microorganisms suitable for use in the present invention are described in U.S. Pat. No. 3,843,517, the contents of which are hereby incorporated by reference.

Particularly preferred microbial products that can be used in the bioremediation blankets of the present invention are hydrocarbon-digesting microbes sold by Microsorb Environmental Products, Inc. of Norwell Mass. MicroSorb® microbes are naturally occurring microbes that convert the contaminant into non-toxic components, thereby eliminating the problem of disposal. These microbes are housed in an inert fine powder carrier which absorbs and locks in the contaminant during bioremediation. The naturally cultured microbes then consume and convert the contaminant. After the contaminant (e.g., oil or fuel) has been consumed, the microbes will either die, return to former natural concentration levels, or be eaten by other organisms.

The microbes may live for 60-90 days once activated. To replenish the microbe colony, microbe powder may be sprinkled on the surface of the blanket on regular intervals or inserted into an optional pouch in the blanket. If sprinkled, the microbes will migrate to the inner layer of the blanket by simply shaking the blanket after sprinkling.

### Absorbing Metals

In addition to employing microbes to digest hydrocarbons, the bioremediation blankets of the present invention may be constructed so as to remove heavy metals—in particular, copper, lead, and zinc—in paints used in painting boats from water being remediated in accordance with the present invention. This may be done by incorporating appropriate materials into the top layer and/or the interior of the present bioremediation blankets. Appropriate materials for this purpose include carbon black, bentonite clay, zeolite, and chitosan. Chitosan is manufactured by grinding shells of crabs, shrimp, lobsters, and the like, and then processing the ground product to remove calcium and protein. Chitosan is available commercially, e.g., from Dungeness Development Associates Inc. of Kirkland, Wash. Free floating metal-absorbing materials are subject to washing out of the blanket, and will generally be used only in applications that involve with low flow rates of water to be remediated. For high flow applications, the metal-absorbing materials are generally provided on a substrate. The cell structure in polymeric foam substrates provides an environment for the material that resists wash out.

### Constructing the Blanket

The bioremediation blankets of the present invention can be made in a wide range of sizes, of varying lengths, widths, and areas. For use as an insert in a catch basin, a bioremediation blanket could be as small as 3 square feet in area. A typical size for the pressure washing of boats is 12 feet wide by 20 feet long, but blankets twice that size will often be required (e.g., depending on the size of the boat). For use in the control of soil erosion, bioremediation blankets of this invention would be designed to fit the specific application. The only limits on the sizes of blankets of the present invention are the limits imposed by manufacturing and handling parameters and economic feasibility.

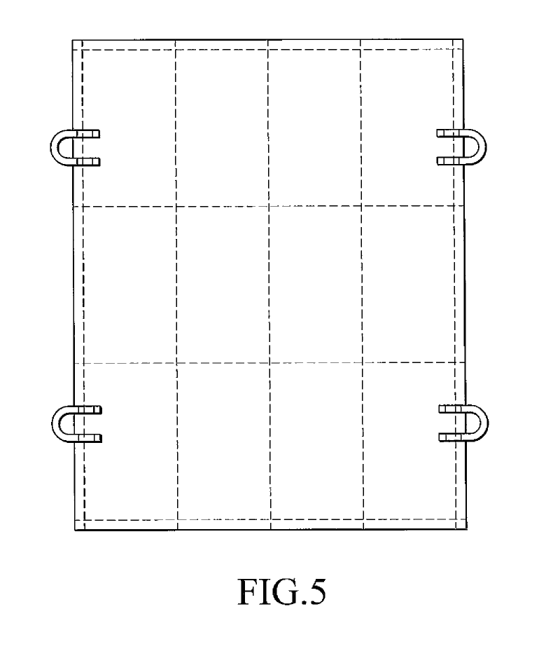

Fabric layers selected to satisfy the requirements of the top and bottom layers in the present invention are joined together around their edges and—for all but the smallest blankets—at intermediate points between their edges, as illustrated in FIG. 5. While sewing is often the most convenient way of joining the layers together, they may if desired be joined together by other techniques well known to those skilled in the art of synthetic fabrics, such as gluing, ultrasonic bonding, and so on. In another embodiment of this invention, microbe-containing powder may be sprinkled on an Absorbent Mat, and the top layer, Absorbent Mat, and bottom layer may then be needle punched together, in that order.

The microbes are housed on or in the top layer and/or between the layers. The microbes may either float freely, or they may be fixed on a substrate such as a polymeric foam or an agricultural product, such as corn starch, soybeans, straw, bagasse, coconut husks, and the like. Free floating microbes are subject to washing out of the blanket, and accordingly this approach to providing microbes in the present invention will generally be used in applications that involve low flow rates of water to be remediated. The problem of microbe wash-out is alleviated somewhat by the rapidity with which the microbes multiply and replenish their own numbers. Also, as described elsewhere in this application, microbes can be added into existing blankets if desired. For high flow applications, the microbes are generally provided on a substrate. It has been found that the cell structure available from polymeric foam substrates provides an environment for the microbes that resists microbe wash out.

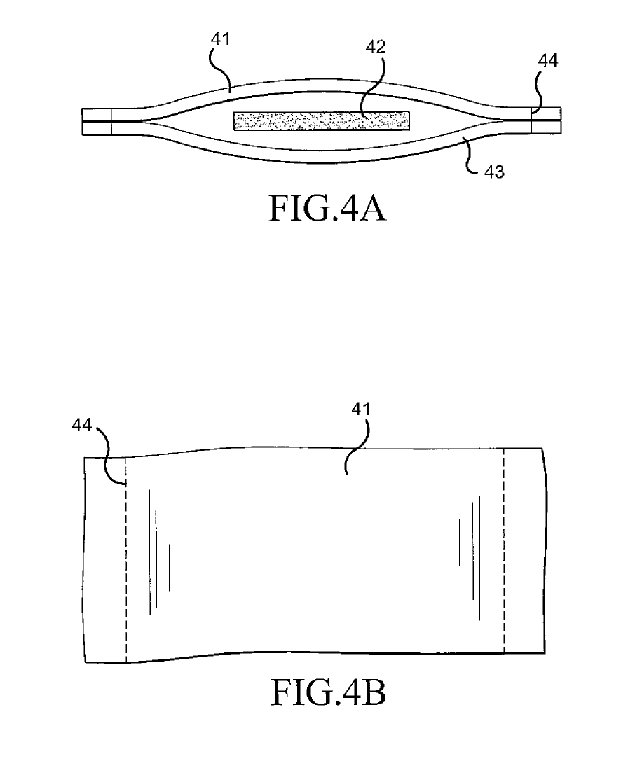

FIG. 4A is a schematic side view of a blanket in which layer (42) illustrates microbes fixed on a polymeric foam substrate, which is located between top layer (41) and bottom layer (43). In FIG. 4A, top layer (41) and bottom layer (43) are joined together near their edges by stitching (44). FIG. 4B is a schematic top view of the blanket of FIG. 4A, in which stitches (44) can be seen located parallel to edges of top layer (41).

If no substrate is employed to house the microbes between the layers, the microbes may be sprayed onto an interior side of a fabric layer or dusted on in powder form or simply placed into a pouch between the layers.

If a substrate is employed the microbes may be sprayed on, dusted on in a powder form, made into tablet form and put into pre-made slits in the substrate layer or be placed on the substrate layer or be put in a biodegradable pouch which would be placed on the substrate. The substrate may float freely within the gap between a top or bottom layer, or may be attached to the textile layer by cross-stitching for maximum effect.

The substrate or carriers can take various forms, such as: open-cell cross-linked polyethylene foams such as opcell or opflex (one such preferred product is manufactured by Collect Foam LLC); closed-cell polyethylene or polypropylene or polyester foams, molded or expanded polystyrenes; open-cell polyurethane foams (see e.g. U.S. Pat. No. 5,264,134), and other appropriate carriers known to persons skilled in the art. The carrier with microbes may also be encased in an outer permeable container such as mesh, for ease of use and further protection for the carrier. In addition to placing microbes into the foam after the foam is foamed, one embodiment of the invention includes the process of mixing the microbes uniformly into the pre-foamed polymer. Then the polymer is foamed. In this way, the microbe is distributed more uniformly throughout the resulting floater. Another embodiment of the invention would have a layer of foam glued to another layer of foam or a layer of fabric or similar substrate, but with a tablet or pellet or powder containing the microbes held between the layers.

In the present invention, the microorganisms are preferably contained in an inert preparation of inorganic material (e.g., bentonite clay). Further, a trace amount of oil (e.g., crude oil or oil on which the microorganisms are weaned) is present in the preparation in order to maintain the microorganisms in a dormant state for storage, transport, etc. As used herein, “trace amounts” also refers to an insignificant amount, or an amount not visible to the eye or readily measurable, or an amount of oil that is so small that it does not add any significant amount of oil to the hydrocarbon to be remediated.

The present invention does not require the addition of any additional nutrient to the biodegradable carrier, tablet/powder, and/or inert material, such as one or more amino acids, nucleic acid bases, vitamins, organic acids, or other growth factors in order to maintain viability of the microorganisms. However, the use of such additional nutrient, if desired, is not excluded by the present invention. Preferably, no enzymes are present in the microorganism preparation.

The microorganism preparation may be placed into the foam to absorb water, hydrocarbons, and metals. That is, the microorganisms within the inert preparation, optionally formed into pellets/tablets or present as a powder, may be inserted into the foam via any opening such as holes, slits, etc., or spread on top of the foam. U.S. Pat. No. 7,166,221 B1, incorporated herein by reference, describes techniques for supporting microbes on powder within slits in synthetic resin foam in bioremediation applications.

The microorganism preparation will dissolve and release the microorganisms into the contaminant during bioremediation. The microorganisms are activated and consume and convert the contaminant into natural byproducts, such as trace carbon, bacterial cells, fatty acids, carbon dioxide, and water. Once the contaminants have been exhausted, the microorganisms will either die, return to former natural concentration levels, or be eaten by other organisms.

### Using the Blankets

The present invention facilitates the safeguarding of the environment, by transforming potential pollutants into environmentally friendly byproducts. This invention may be used in connection with both commercial and recreational boats, in marinas, in papermaking plants, in polluted areas corded off by floating booms, for soil erosion, under parked vehicles, on rooftop gardens, on highway overpasses, in kitchen grease traps, in water run-off catch basins, in sewer systems, in wetlands, in streams, in lakes, and so on—virtually anywhere that undesirable hydrocarbons are present in connection with water.

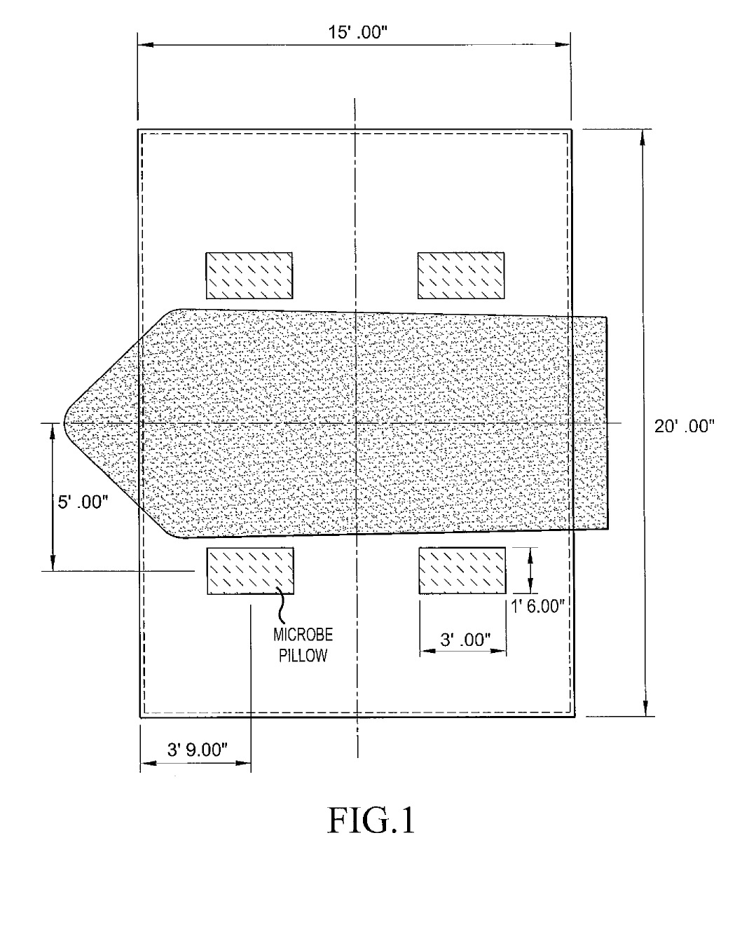

The blanket may also have industrial applications such as cleaning up boats that were in an oil spill. For instance, FIG. 1 shows a boat placed on a blanket of the invention. The boat is pressure washed and the large debris such as paint chips are collected in the outer most layer of the blanket. The oil then penetrates the blanket and is cleaned by the action of the microbes.

### EXAMPLES

In preferred embodiments, a substrate is used to house the microbes between the top and bottom layers of the blanket. The substrate may be a reticulated urethane open cell foam, e.g. a 40-pore-per-inch foam manufactured by Foamex or a similar open cell reticulated foam made by Avitar Technologies, or a green mat as manufactured by Huesker Inc., or may be an open cell crosslinked polyethylene foam, e.g. as manufactured by Cellect Foam LLC. Oil and other hydrocarbons cling to the foam. Water will flow through the reticulated foam but not through the crosslinked foam. To provide for flow-through on the crosslinked foam, it is perforated and sewn (cross-stitched) to the bottom layer of the blanket in sections in the manufacturing process. Microbes housed in a bentonite clay carrier are spread on the surface of the foam, allowing the microbes to bioremediate the hydrocarbons and letting the bentonite clay absorb metals from the effluent. The pin holes created by the perforation and the cross-stitching create gaps between sections of the foam, allowing for a slow flow of water through the interior layer, providing more time for the microbes and bentonite to effect bioremediation. In another embodiment, the crosslinked foam may be pre-punched with holes or slits to facilitate the flow of water through it.

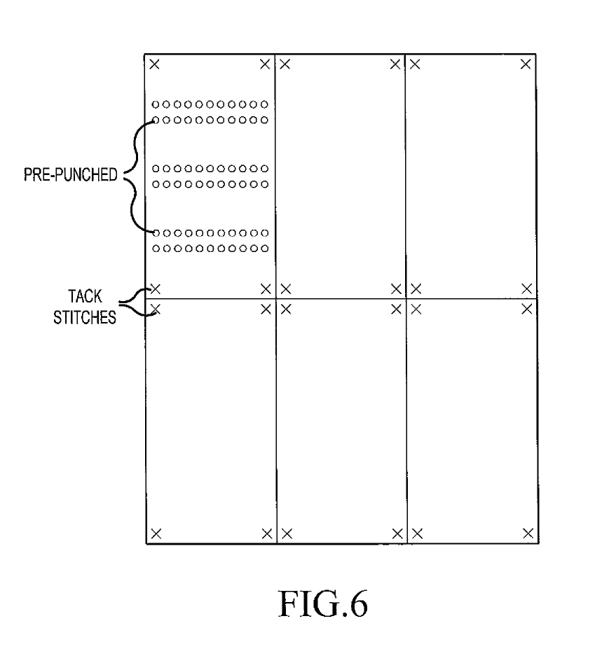

In a typical manufacturing process, a nonwoven (felt) polypropylene fabric—which will become the “top” layer—is laid out on the floor, and microbes are sprinkled directly onto the fabric laid out on the floor. Upon completion of the manufacturing process, the fabric surface upon which the microbes are sprinkled will be within the interior of the blanket. Foam sheets (e.g., open cell crosslinked polyethylene foam) are perforated on a sewing machine. The foam sheets are hand stitched (“tacked”) to the nonwoven layer to prevent shifting during construction. FIG. 6 illustrates die-cut or pre-punched holes in foam sheets and foam sheets tacked to the “top” layer at this intermediary stage of construction. A woven polypropylene monofilament layer (6% open weave) is hand stitched on top of the nonwoven layer, sandwiching the foam sheets between the two layers. The resulting loosely “tacked” sandwich construction is run through a sewing machine, in which it is sewed by lengthwise and widthwise cross-stitching, with approximately 3 feet between each of the stitch lines. A 9′×12′ blanket would thus have 5 cross-length stitch lines and 4 cross-width stitch lines, as illustrated in FIG. 5. Once the blanket is securely joined by sewing, it may be squared and trimmed as necessary.

Subsequently, lifting loops—i.e., handles—may be sewn to the blanket to facilitate handling, as illustrated in FIG. 5.

Also, in order to provide an upright retention band around the top surface of the blanket, “pipe boots” may be sewn around the perimeter of the blanket. These could be sleeves of, for instance, orange vinyl, dimensioned to contain PVC pipe inserts to provide them with rigidity. The “pipe boots” would typically be hand welded closed at the corners of the blanket.

Another application of the bioremediation blanket of the present invention is use underneath parked vehicles in garages, for instance, fire engines, to absorb and treat water and hydrocarbon fluids dripping from the engine compartments of the vehicles. A convenient size blanket for this application is 6 feet by 4 feet. These blankets could have an upright retention band around their top surface, as discussed above.

Yet another application of the present invention is on top of roof gardens on buildings or on overpasses on highways, where the microbes would digest not only hydrocarbons but also unwanted animal waste.

In preparation for its transportation, a completed blanket may be folded into a package of manageable size and tied together to facilitate its transportation to its ultimate place of use.

### INDUSTRIAL APPLICABILITY

The bioremediation blanket of the present invention has a multiplicity of uses. It may, without limitation, be used to clean up ponds, streams, lakes, lagoons, rivers, and other bodies of water anywhere hydrocarbons are a problem. The blanket can be used in rooftop gardens to address the problem of hydrocarbons and animal waste. It can also be used in the management of stormwater run off as well as under boats in pressure washing. Other uses are described herein, and still other uses will readily occur to persons skilled in the art.

This invention provides a low cost method of trapping sediments on the surface and of collecting them and also bioremediating organic pollutants. Bioremediation blankets of the invention can be made in virtually any size, and can be maintained and cleaned for re-use. Handles can be permanently attached to the blankets to facilitate handling them. The blankets can be moved easily from site to site, and easily rolled up for storage. Bioremediation blankets made in accordance with the present invention are remarkably cost effective.

Prior to this invention there was no technology that was inexpensive and was portable that could easily both contain sediments and bioremediate the pollutants generated in storm water runoffs and in pressure washing. The present technology can also be applied to putting greens and golf courses. The blanket protects turf on putting greens while the microbes enhance the root systems of the grass as it is germinating. The blanket of this invention can also be deployed on ponds to capture sediments. Additionally, the blanket of this invention can be used in soil erosion control, e.g., as a 3-dimensional grid mat used between layers of blocks in retaining walls. The function of the mat here is to stabilize the soil so that grass seed will not wash away. The microbes in the mat of the present invention will enable the root structure of the grass to proliferate.

What is claimed is:

1. A bioremediation blanket comprising:
a top layer of an oleophilic nonwoven geotextile fabric adapted to capture and remove material floating in water and to contain the material removed from the water on the blanket and to allow hydrocarbons to flow through the top layer to an interior of the blanket;
a bottom layer of geotextile fabric comprising a woven monofilament layer adapted to release water from which hydrocarbons have been removed; and
microbes adapted to digest hydrocarbons, said microbes being provided on or within the top layer and/or between the top layer and the bottom layer.

2. The bioremediation blanket of claim 1, comprising:
an interior layer which comprises said microbes and a polymeric or agricultural product substrate support for the microbes and which optionally comprises a material to absorb heavy metals present in the interior layer.

3. The bioremediation blanket of claim 2, which contains a polymeric foam substrate support for the microbes.

4. The bioremediation blanket of claim 1, which contains bentonite clay, carbon, zeolite, or chitosan to absorb copper, lead, zinc, or paint chips.

5. The bioremediation blanket of claim 1, wherein the blanket comprised of layers of geotextile fabrics and microbes is needle punched.

6. The bioremediation blanket of claim 1, wherein top layer a) has a flow rate of at least about 70 gallons per minute per square foot.

7. The bioremediation blanket of claim 6, wherein top layer a) has a flow rate of approximately 80 gallons per minute per square foot.

8. The bioremediation blanket of claim 1, wherein the bottom layer c) comprises a woven polypropylene monofilament fabric.

9. The bioremediation blanket of claim 1, wherein bottom layer c) has a flow rate of at least about 15 gallons per minute per square foot.

10. The bioremediation blanket of claim 9, wherein bottom layer c) has a flow rate of approximately 18 gallons per minute per square foot.

11. The bioremediation blanket of claim 1, wherein the top layer has an upright border extending along its entire perimeter, adapted to contain water, barnacles, paint chips, and sediments.

12. The bioremediation blanket of claim 11, wherein the perimeter border is configured to contain an internal member which imparts rigidity to the border.

13. The bioremediation blanket of claim 1, configured with two or more handles to facilitate handling and moving the blanket.

14. The bioremediation blanket of claim 1, wherein the microbes are in the form of a tablet, powder, or liquid.

15. The bioremediation blanket of claim 3, wherein the microbes are located on and/or within said polymeric foam, and said polymeric foam is positioned on an interior side of one of the layers of the blanket or between two layers of the blanket.

16. The bioremediation blanket of claim 15, wherein the microbe-containing foam is attached inside of the top layer of the blanket.

17. The bioremediation blanket of claim 1, wherein the microbes are located within a gap between the top layer and the bottom layer of the fabric.

18. The bioremediation blanket of claim 1, wherein no enzymes are present in the microorganism preparation.

19. The bioremediation blanket of claim 1, wherein nutrients for the microbes are added to the blanket.

20. A method for removing hydrocarbons from water, which comprises:
providing a bioremediation blanket in accordance with claim 1;
allowing water containing hydrocarbons to contact and penetrate the blanket; and
allowing the microbes within the bioremediation blanket to digest the hydrocarbons.

21. The method of claim 20, further comprising removing material floating in the water and retaining the material removed from the water on the blanket.

22. The method of claim 20, further comprising allowing water, from which hydrocarbons and dissolved metals have been removed, to flow out of the blanket.

23. The method of claim 20, wherein said bioremediation blanket is provided, top side up, underneath an engine compartment of a parked motor vehicle, or is provided on a rooftop garden.

24. The method of claim 20, further comprising removing material from the blanket in order to clean and reuse the blanket.

25. A method for pressure washing a boat, which comprises:
providing a bioremediation blanket in accordance with claim 1;
placing said bioremediation blanket, top side up, underneath a boat;
pressure washing said boat and allowing water containing hydrocarbons generated by said pressure washing to contact and penetrate the blanket; and
allowing the microbes within the bioremediation blanket to digest said hydrocarbons.
